(19) United States
(12) Patent Application Publication
(10) Pub. No.: US 2023/0106833 A1
(43) Pub. Date: Apr. 6, 2023

(54) Composite PTFE plating

(71) Applicant: SURFACE TECHNOLOGY, INC, Ewing, NJ (US)

(72) Inventors: Michael Feldstein, Princeton, NJ (US); Doan Nguyen, Ewing, NJ (US)

(21) Appl. No.: 17/755,765

(22) PCT Filed: Oct. 6, 2021
(86) PCT No.: PCT/US21/53736

§ 371 Date: May 6, 2022

(51) Int. Cl. C23C 18/34; C08L 27/18

(52) U.S. Cl. CPC C23C 18/34; C08L 27/18

(57) ABSTRACT

The present invention is directed to compositions, baths, and methods for composite plating where the composition and subsequent plating include polytetrafluoroethylene (PTFE), and more particularly, to compositions, baths, and methods of composite plating with PTFE included in a metal or alloy matrix where the materials used in the process, including materials in the composition, include no or essentially no PFAS (perfluoroalkyl substances) including PFOS (perfluorooctane sulfonate), GenX, PFOA (perfluorooctanoic acid), and/or fluorinated surfactants.

### BACKGROUND OF THE INVENTION

The present invention relates in general to composite plating, composite plating compositions, articles plated in such compositions, and more particularly to a process of composite plating resulting in polytetrafluoroethylene (PTFE) in a metal or alloy matrix where the materials used in the process contain no or essentially no PFAS (perfluoroalkyl substances) including PFOS (perfluorooctane sulfonate), PFOA (perfluorooctanoic acid), GenX, and/or other fluorinated surfactants or components with fluoride in any form.

The electroless plating of articles or substrates with a composite coating containing finely dispersed particulate matter is well documented.

Electroless plating generally involves the deposition of metal alloys by chemical or electrochemical reduction of aqueous metal ions. Through such deposition, the process of electrolessly metallizing a desired metal coating over an article or substrate is achieved.

The fundamentals of composite electroless plating are documented in a text entitled “Electroless Plating Fundamentals and Applications,” edited by G. Mallory and J. B. Hajdu, Chapter 11, published by American Electroplaters and Surface Finishers Society (1990.

As opposed to conventional electroless plating methods, in composite electroless plating, insoluble or sparingly soluble particulate matter is intentionally introduced into a bath solution for subsequent co-deposition onto a substrate or article as a coating.

Early patents related to composite electroless plating include U.S. Pat. No. 3,644,183 (Oderkerken), in which a structure of composite electroless plating with finely divided aluminum oxide was interposed between electrodeposited layers to improve corrosion resistance. U.S. Pat. Nos. 3,617,363 and 3,753,667 (Metzger, et. al.) utilized a great variety of particles and miscellaneous electroless plating baths. Thereafter, Christini, et. al., in Reissue Pat. No. 33,767, further extended the composite electroless plating technique to include the co-deposition of diamond particles.

U.S. Pat. No. 8,598,260 (Feldstein, et. al.) relates to composite plating with PTFE including the desirability to reduce or avoid the use of certain materials such as PFOS and/or PFOA, and is incorporated herein by reference.

The co-deposition of particles in composite electroless plating can dramatically alter or enhance existing characteristics and even add entirely new properties. These capabilities have made composite electroless coatings advantageous for a variety of reasons including, but not limited to, increased utility in conditions requiring less wear and lower friction; facilitating the use of new substrate materials such as titanium, aluminum, lower cost steel alloys, ceramics, and plastics; allowing higher productivity of equipment with greater speeds, less wear, and less maintenance related downtime; and replacing environmentally problematic coatings such as electroplated chromium which is a significantly toxic metal.

In addition, commercially viable composite electroless coatings are essentially homogenous, uniform, or regenerative, meaning that their properties are maintained even as portions of the coating are removed during use. This feature results from the uniform manner in which the particles are dispersed throughout the entire plated layer. Uniformity, however, requires careful consideration of the component elements and the composition and control of the bath properties.

Commercially viable composite electroless, and conventional electroless plating processes with particles, must operate at certain levels of performance in a number of parameters. Such parameters include: plating rate of the plating bath, surface area of immersed workpieces able to be plated per volume of the plating bath, stability of the plating bath, ability to replenish the plating bath with continued used of the plating bath, lifetime of the plating bat, usually described in terms of metal turnovers, and other parameters.

Coating products using composite plating, especially metalized plating and more particularly electroless nickel with PTFE, have come into widespread commercialized use around the world in many industries such as those including high speed components, automotive applications, molds, electronic connectors, textile manufacturing components, material handling devices, machining and tooling parts, cookware and other food handling equipment, medical devices, gears, and others.

Composite plating with PTFE is accomplished by adding appropriate amounts of a dispersion containing PTFE particles into the plating bath generally containing a metal such as electroless nickel. The PTFE dispersion is formulated to break up any agglomerates, such as of PTFE, resulting from the manufacture of the PTFE or other reasons and encapsulate the PTFE particles with certain chemicals that allow the PTFE to be introduced and function properly in the plating bath, and ultimately in the coating itself.

However in recent decades, health and environmental concerns were raised about the inclusion of certain materials in PTFE dispersions, including PFOS and PFOA, that are used in composite plating systems. Some of these concerns were noted in U.S. Pat. No. 8,598,260.

More recently such concerns have increased and expanded to include a broader classification of materials classified as perfluoroalkyl substances (PFAS). Broadly speaking, PFAS may be toxic and/or carcinogenic. PFAS includes PFOA, PFAS, and GenX, but is not limited to them. In particular, some materials in PTFE dispersions, such as but not limited to some PFAS materials, ordinarily become included in the plating, and these materials are believed to have tendencies to later migrate from the plated objects into or onto other items, including humans and animals. For example, PTFE is commonly used in plating cookware and, at times, small quantities of the plating material, including PTFE and any materials in the PTFE plating, may be absorbed by the foods prepared in the cookware. Another example is in components used in consumer and industrial products such as automotives, electronics, and others which may ultimately be disposed and the disposition may lead to exposure or transfer of the PFOA or PFOS into the environment. More recent concern also includes the potential of PFAS migrating into drinking water supplies from plated products and/or the manufacture of the products which includes the manufacture and use of PTFE dispersions used in plating such products. While at most few such situations have been documented, the possibility exists and there is interest in taking mitigation steps at the time of manufacture.

A demonstration of the recent concern by the United States Environmental Protection Agency (EPA) to the broader category of PFAS substances can be seen on the agency's website: https://www.epa.gov/pfas/basic-information-pfas

In 2021, The National Association of Surface Finishing (NASF) organization has published a significant amount of information related to PFAS in the surface finishing industry that includes the plating industry. On their website, the NASF has an entire section devoted to PFAS. (https://nasf.org/pfas/) This information includes an explanation of PFAS, its uses in the surface finishing industry, and regulatory issues designed to reduce or eliminate PFAS, especially in the interest of keeping PFAS out of drinking water supplies. Plating is a key segment of the surface finishing industry.

Specifically, it is desirable to reduce or greatly eliminate PFOA, PFOS, GenX, PFAS and fluorinated materials from such systems.

Accordingly, there is still an unsolved need for further improvements in composite PTFE plating solutions and methods, whereby PFOS, PFOA, GenX, PFAS, and fluorinated materials are eliminated or greatly reduced.

PFAS, including GenX, PFOA, and PFOS, has become the topic of health and environmental concerns. These PFAS-laden materials have been found to not decompose over time and are believed to have negative health and environmental impacts. These materials have been found in human and animals' blood around the world, and it is a concern that these materials persist without decomposing. Terms like biocumulative and biopersistent have been used to describe these materials.

PFOS containing materials are used on an even broader scale than just composite plating. Other applications include fume and fire suppression, sealers, and others.

The 3M Company, a major manufacturer of products containing PFOS, discontinued its manufacture in the year 2000 of PFOS chemicals.

The United States Environmental Protection Agency had ruled that PFOS may not be manufactured or imported into the United States. United States companies may still use existing supplies of PFOS as long as the PFOS is not newly manufactured or imported into the United States. However, it is clear that the avoidance of PFOS and PFOA is a desirable and prudent goal given the concerns over these materials, and considering that they may eventually be banned from use as well as manufacture and importation to the United States.

Therefore, an object of the present invention is to provide PTFE dispersions useful in composite plating where these dispersions are free or essentially free of PFAS and other fluorinated compounds, including GenX, PFOA and/or PFOS.

### BRIEF SUMMARY OF THE INVENTION

The present invention is directed to compositions, baths, and methods for composite plating including PTFE as a plating component, but absent, at trace amounts, or at sub-trace amounts of PFAS and/or other fluorinated materials, including but not limited to GenX, PFOA, and/or PFOS.

Because PTFE is an especially difficult material to incorporate into plating baths and subsequently into coatings, the properties that make PTFE non-stick, including instability, also make PTFE particles difficult to wet and combine with the surfactants that apply a charge to the particle. This charge is the means by which the particles are dispersed uniformly into the plating solution, and maintained as such in the bath and the plating without substantial agglomeration, allows them to be co-deposited into the coating.

The inclusion of insoluble particulate matter in composite electroless baths introduces additional instability of the bath. To overcome the extra instability due to the addition of insoluble particulate matter to the bath, as described in U.S. Pat. No. 6,306,466, the general use of particulate matter stabilizers (PMS) is believed to isolate the finely divided particulate matter, thereby maintaining the particular matter's “inertness”. Also, particulate matter stabilizers, such as surfactants, tensides, wetters, dispersants and other materials, tend to modify the charge on the particulate matter to further maintain inertness. Altogether, by a precise addition and type of particulate matter stabilizers, one may overcome the instability issues directly related to the addition of insoluble particulate matter to the plating baths, as shown in U.S. Pat. Nos. 4,997,686, 5,145,517, 5,300,330, 5,863,616 and 6,306,466.

In electroless plating systems, a dispersion containing PTFE particles is added to an electroless plating bath. Without the dispersion product in the plating bath, the plating bath would produce a metal or alloy plating or coating onto one or more articles that are immersed in the plating bath under proper conditions. The electroless plating bath itself comprises ingredients as described elsewhere in the present invention in more detail but would typically not include particulate matter unless the particulate matter is added to the plating bath such as through the addition of a dispersion containing particulate matter into the plating bath. By adding a dispersion product containing PTFE to an electroless plating bath, a coating of a metal or alloy that contains PTFE can be formed onto one or more articles immersed in the plating bath under proper conditions. The dispersion includes PTFE particles (the form also known as powder, micro-powder and by other terms) plus one or more surfactants (also referred to herein as particulate matter stabilizers, wetters, dispersants, tensides and other terms).

In describing the present invention, the terms PMS, particulate matter stabilizer, surfactant, wetter, dispersant, tenside, and other related terms may be used interchangeably in their singular and plural forms, as they often are in the plating industry.

Commercially available dispersions are generally about sixty percent by weight PTFE solids. Prior to U.S. Pat. No. 8,598,260, one or more of the surfactants used in such dispersions were typically fluorocarbon materials that contain PFOS.

All composite PTFE plating solutions and methods known in the art prior to U.S. Pat. No. 8,598,260, including the art referenced above, knowingly or unknowingly incorporate PFOS in the plating process. Specifically, PFOS was included in one or more of the commercially available surfactants and/or particulate matter stabilizers that have been used to disperse PTFE particles and make them compatible with the plating process, and to assure uniform distribution of the PTFE in the resultant plating. PFOS had historically been used because the surfactants or particulate matter stabilizers most readily available, common in the composite plating field, and effective contain PFOS. PFOS containing materials had been the industry standard in such PTFE dispersions and plating baths due to the high level of stability which the PFOS material provides to both the PTFE dispersion alone and to the performance of the composite plating bath using PTFE from such dispersions. The present invention is directed at least in part to dispersions and methods of their use, which provide high levels of stability and performance at significantly lower levels of PFOA, PFOS, GenX and other fluorinated materials in the resultant plating or none in some or all of the dispersion components and ingredients.

PFOS is a molecule containing eight carbon atoms and sixteen fluorine atoms. The electronegativity of the fluorine atom helps a surfactant adsorb onto particles such as PTFE. Shorter carbon chain surfactants contain fewer fluorine atoms and are therefore less effective than an eight chain PFOS surfactant. For example, a six carbon chain (or C6) surfactant contains only twelve fluorine atoms as there are two fluorine atoms for every one carbon atom. For the purposes of this discussion, a surfactant is meant to include all varieties of surfactants, wetting agents, dispersants, particulate matter stabilizers and like materials. A surfactant with less electronegativity than provided in a PFOS surfactant will be less able or impossible to adsorb onto PTFE particles. A modified dispersion formulation and/or process may be needed to include a surfactant with less electronegativity than PFOS to adsorb onto PTFE particles, if it is even possible, with sufficient utility for plating applications. Surfactants with less electronegativity include fluorocarbon surfactants with less than eight carbon atoms, hydrocarbon surfactants, and others. If the surfactants used in the dispersion of the PTFE particles have less electronegativity than those provided by PFOS, and the adsorption onto the PTFE is weaker than what it would be with a PFOS surfactant, and the PTFE dispersion could be less stable, meaning that the PTFE is more prone to settling, floating, agglomerating, or otherwise de-wetting, and hence not being a stable dispersion able to handle commercially acceptable shelf life, storage, transportation, temperature changes in the above. Such a dispersion could also not be in suitable condition for use in a plating bath. In the plating bath, stability of the PTFE from a dispersion using surfactants with less electronegativity than PFOS surfactants can also be lower, and hence exhibit drawbacks or failures such as the de-wetting of PTFE particles in the plating bath.

Fluorinated surfactants with carbon chains that are less than eight such as C6 or less are still subject to regulatory, health and/or environmental concerns.

De-wetting of the PTFE particles in the plating bath is most commonly witnessed by the PTFE particles agglomerating within the plating bath and/or floating on top of the surface of the plating bath. Factors such as high temperatures, chemistry, pH, and agitation make the PTFE particles more likely to de-wet in the plating bath. Naturally, if the PTFE particles float, agglomerate, or otherwise de-wet in the plating bath, these particles will not be useful in the plating bath for co-deposition as desired onto an article. Adding more PTFE dispersion into a plating bath to compensate for de-wetted particles is a costly and likely ineffective option as the newly introduced PTFE particles are likely to also de-wet, and the additional PTFE dispersion introduced to the plating bath may negatively affect the performance of the plating bath.

De-wetted PTFE particles in the plating bath can cling to the surface of articles immersed in the plating bath for plating, thereby causing plating defects. De-wetted particles in the plating bath and the subsequent imbalance between wetted particles, one or more surfactants, and the plating bath can also cause plating defects, poor performance of the plating bath, and/or other problems.

PFOA is a polymerization aid that has been used in the manufacture of PTFE, and historically for this reason some concentration of PFOA, in addition to PFOS, was generally included in PTFE used in plating. Use of PFOA as a polymerization aid in the manufacture of PTFE has certain significant influences and advantages in PTFE dispersions in composite plating baths, and on articles produced from such plating baths.

When the PTFE particles are produced, they have commonly historically been produced with PFOA as a polymerization aid. It is possible however to modify the process of PTFE manufacturing to produce PTFE without PFOA as a polymerization aid. Some manufacturers of PTFE have been able to reduce the PFOA content of their PTFE products suitable for PTFE dispersions to trace levels. Trace levels were typically in the concentration of parts per million and in hundreds of parts per million.

While not wanting to be bound by theory, the manufacturing process of PTFE micropowders can create end groups that can form PFOA end groups, even in PTFE that was produced without PFOA as a polymerization aid. An irradiation treatment typically involved in the production of sub-micron PTFE powders, which are especially useful in plating applications, can also cause the formation of PFOA within the PTFE.

PTFE materials including powders are available in virgin and recycled products. The use of PTFE powders made from recycled PTFE materials pose an additional challenge as the source materials may contain any or all of PFOA, GenX, or other PFAS substances. The present invention uses PTFE which is free or essentially free of such substances.

In 2010, E.I. du Pont de Nemours and Company and Chemours the subsequent owner of the Teflon® PTFE brand, began replacing the use of PFOA in the manufacture of PTFE with another processing aid material known as GenX. This replacement was related to the United States Environmental Protection Agency 2010/2015 voluntary PFOA Stewardship Program. Gen X has the following chemical structure: CF₃CF₂CF₂OCF(CF₃)COOH.NH₃. However, GenX is a PFAS compound and according to various reports GenX is as hazardous or more hazardous to human health than PFOA is. https://www.ewg.org/news-insights/news-release/epa-genx-nearly-toxic-notorious-non-stick-chemicals-it-replaced and https://www.sciencedirect.com/science/article/pii/S0045653518324706 and https://ehp.niehs.nih.gov/doi/10.1289/ehp5134 are examples of the issues related to GenX. The presence of GenX in PTFE powders may have been hazardous like PFOA, but GenX was also advantageous to the performance of PTFE powders in dispersions used in plating applications.

Shamrock, another supplier of PTFE materials for the ink and coatings industry, reported in January 2020 that it had modified its manufacturing process to reduce the amount of PFOA in PTFE micropowders to meet the limitation of 25 parts per billion specified in the European Union's Registration, Evaluation, Authorisation, and Restriction of Chemicals (REACH) regulation, as published by the European Commission of the European Union, that was slated to take effect on Jul. 4, 2020. https://www.coatingsworld.com/issues/2020-03-01/view_online-exclusives/producing-reach-compliant-ptfe-additives-for-coatings-inks/

The European Regulation is known as EU 2017/1000 under Annex XVII includes the following, “From Jul. 4, 2020, mixtures and articles placed on the market in the European Union will require a concentration of ≤25 ppb of PFOA and ≤1000 ppb of one or a combination of PFOA related substances”.

When such a material, with a concentration in the range of ppb is used, the resultant dispersion has at most less than 15 ppb if the dispersion is a typical 60% by weight of PTFE particles, a measure far lower than what was earlier viewed in the industry as “trace” amounts. We define this under 100 ppb concentration as “sub-trace”.

Other countries are anticipated to also establish this or similar limitations. Regulations may include specific concentrations for individual PFAS materials and may include limitations on the sum of multiple PFAS compounds. This potential cumulative sum regulation makes the utility and novelty of the present invention to reduce or eliminate PFAS materials of even greater importance. Certain PFAS materials are of greater concern than others by regulatory agencies such as REACH, and this will evolve depending on the nature of the material and the ability or methodology to analyze for such materials. These evolving regulations further make the utility of the present invention to reduce or eliminate PFAS materials as in the present invention of even greater importance.

The formulations and methods of producing PTFE dispersions established in the field of composite plating have been based on the properties of PTFE particles manufactured with PFOA as a polymerization aid. The dispersion and use of such PTFE dispersions in composite plating is a sensitive balance requiring significant adsorption of surfactants onto PTFE particles which are not readily wettable. The type, composition, charge, particles size, degree of agglomeration, surface area, and other factors are essential in the degree of stability or instability of the PTFE particles within a dispersion and/or plating bath. Moreover, the coordination between the quantity, combinations, and charges of the surfactants and the type, composition, charge, particles size, degree of agglomeration, surface area, and other factors of the PTFE particles is essential to the ultimate stability and utility of the PTFE in the dispersion and/or of the plating bath. Any alteration to one of the materials may require adjustment to some or all of the other parameters, if even possible, to still produce an effective product, process, and article from such a process. In terms of PFOA specifically, its use as a polymerization aid affects the composition of the PTFE, the base particle and/or agglomerate size of the PTFE material. PTFE particles manufactured with less or no PFOA require different surfactants, combinations of surfactants and/or methods of dispersion in order to make such PTFE suitable for use in a dispersion and subsequent plating bath.

In accordance with one embodiment of the present invention, there is described a process of electrolessly metallizing an article to provide on its surface a metal coating containing PTFE particulate matter, in which the PTFE dispersion and electroless metallizing bath are essentially free of PFOA and PFOS.

In accordance with one embodiment of the present invention, there is described a process of electrolessly metallizing an article to provide on its surface a metal coating containing PTFE particulate matter, in which the PTFE dispersion and electroless metallizing bath are essentially free of PFAS.

In accordance with one embodiment of the present invention, there is described a process of electrolessly metallizing an article to provide on its surface a metal coating containing PTFE particulate matter, in which the PTFE dispersion and electroless metallizing bath has less than one part per million of PFOA.

In accordance with one embodiment of the present invention, there is described a process of electrolessly metallizing an article to provide on its surface a metal coating containing PTFE particulate matter, in which the PTFE dispersion and electroless metallizing bath are compliant with REACH.

In accordance with one embodiment of the present invention, there is described a process of electrolessly metallizing an article to provide on its surface a metal coating containing PTFE particulate matter, in which the PTFE dispersion and electroless metallizing bath, each has less than 25 parts per billion of PFOA.

In accordance with one embodiment of the present invention, there is described a process of electrolessly metallizing an article to provide on its surface a metal coating containing PTFE particulate matter, in which the PTFE particulate matter in the PTFE dispersion has less than 25 parts per billion of PFOA.

In accordance with another embodiment of the present invention, there is described an article with a coating, in which the coating contains an electroless metal and PTFE particulate matter, and is free or essentially free of GenX, PFAS, other fluorinated surfactants, PFOA, and PFOS.

In accordance with one embodiment of the present invention, there is described a PTFE dispersion useful for plating wherein the dispersion is essentially free of PFAS.

In accordance with one embodiment of the present invention, there is described a PTFE dispersion useful for plating wherein the dispersion is essentially free of PFOS.

In accordance with one embodiment of the present invention, there is described a PTFE dispersion useful for plating wherein the dispersion has less than one part per million of PFOA.

In accordance with one embodiment of the present invention, there is described a PTFE dispersion useful for plating wherein the dispersion has less than 25 parts per billion of PFOA.

In accordance with one embodiment of the present invention, there is described a PTFE dispersion useful for plating wherein the dispersion is compliant with REACH.

In accordance with one embodiment of the present invention, there is described a PTFE dispersion useful for plating wherein the dispersion is essentially free of GenX.

In accordance with one embodiment of the present invention, there is described a PTFE dispersion useful for plating wherein the dispersion is essentially free of fluorinated surfactants.

### DETAILED DESCRIPTION OF THE INVENTION

In describing the preferred embodiments of the present invention, specific terminology will be resorted to for the sake of clarity. However, the invention is not intended to be limited to the specific terms so selected, and is to be understood that each specific term includes all technical equivalences which operate in a similar manner to accomplish a similar purpose.

In the practice of the present invention, a PTFE dispersion is formulated by adding together PTFE particulate matter, one or more surfactants also referred to as wetters, dispersants, tensides and particulate matter stabilizers, and other ingredients as needed. In a preferred embodiment, the PTFE dispersion is ultimately combined with a composition for metalized plating which is useable for plating one or more objects by use of a plating bath.

In the practice of the present invention, the dispersions of PTFE particulate matter have a preferred concentration of PFOA less than 1 part per million and more preferably less than 25 parts per billion or even fewer. This level of PFOA is significantly lower than the prior art that did not define the permissible amount of PFOA that would be considered “trace”.

The reduction of PFOA to the level required by the present invention from the manufacture of PTFE powder by the manufacturers of PTFE requires a significant alteration of their process of manufacturing the PTFE powder and ultimately to the plating formulations and processes of the present invention. The resulting PTFE powder consequently also has different properties from earlier PTFE powder, and the dispersions differ as well. Even the previously considered trace amounts of PFOA in the parts per million up to hundreds of parts per million make a significant difference in both the manufacture and use of PTFE powders, especially in a sensitive and complex application such as composite plating, and especially in the context of the present invention wherein GenX, PFOS, other fluorinated surfactants, and/or other materials may not be used. PTFE produced by different methods of manufacture not only have different compositions of PTFE, PFOA, GenX, and other materials, but depending on which method of manufacture is used to produce PTFE the process can have other physical effects on the resulting PTFE and therefore change the stability of the PTFE particles within the plating bath, specifically their ability to remain wet and dispersed in the plating bath without agglomerating, floating or otherwise de-wetting and therefore not being present in proper form and concentration to co-deposit onto the immersed article in the plating bath and form the desired coating. The present invention is directed at least in part to a family of PTFE dispersions.

PTFE is generally manufactured as a dry powder usable in metalized plating baths where the PTFE adheres to the plated object within the metal plating. At times, different PTFE-based plating baths may behave differently as a consequence of the PTFE powder manufacturing process. For example, the method of manufacture of PTFE influences the basic particle size, particle agglomeration, surface area of the PTFE material, and other physical properties. Such properties and others affected by the method of manufacture of the PTFE with as little PFOA as in the present invention have implications for the use of such PTFE in dispersions useful for plating applications. Irradiation of the PTFE material during the manufacturing process can also influence the composition, size, shape, pH, hardness, other physical properties, and ultimately performance of the PTFE powder. Alteration of the chemistry and method of manufacture of such dispersions in order to utilize PTFE with so little or no PFOA or other fluoride encompassing materials in such dispersions is therefore required, especially to produce such dispersions that meet the highest standards of commercial practice. Further, because of extensive differences and inconsistencies possible with PTFE powders manufactured to the PFOA level of the present invention (e.g., ppb), properties of plating baths using these PTFE particles, such as regenerability, lifetime, and stability, have wide variability and there is a need for a cost effective and repeatable plating bath and plating process to overcome these variabilities. The present invention is directed to solving this set of problems.

In addition, because of the use of PTFE with such little fluoride content, the types and quantities of surfactants are key to success of the present invention. That is, the present invention is directed to formulations and methods of use of PTFE dispersions, where the PTFE is at very low (lower than previously disclosed in the prior art) levels of fluoride and where little to no additional fluoride-included components are included in the dispersions for plating.

Dispersions of PTFE useful in the present invention are intended to have the desirable properties of uniform particle size, minimal agglomeration in bath and plating, stability in storage including at high and low temperatures, compatibility with the parameters and process of use. Dispersions of PTFE for plating must have these properties for commercial use. Such dispersions may demonstrate some settling of the PTFE and a supernatant liquid over time in storage or transportation. It is typically necessary that dispersions suitable for commercial plating should be able to be mixed to a homogeneous condition by the plating end-user. This can be accomplished by manually shaking the PTFE dispersion in the dispersion container or another container, and/or utilizing a mechanical device to mix the PTFE dispersion alone, with water, and/or a portion of the plating bath. The present invention includes dispersions meeting this need.

Further, PFOS when used in PTFE metalized plating processes, associates with the metal/PTFE coating, is included in the metalized plated material, and, like PFOA, exhibits migration characteristics akin to those of PFOA.

For health and environmental reasons akin to those regarding PFOA, there is a desire to avoid or greatly reduce PFOS in plating. In the practice of the present invention, the PTFE dispersion may be free of PFOS, or substantially free of PFOS, as traces of PFOS exist in many materials, and therefore the present invention relates to products with as little PFOS possible, no more than in the ppb or sub-trace range, measured according to material availability and limitations of detection by the prevailing analytic methods. In general, trace amounts as the term is used herein are those in which the concentration of PFOS in a bath are less than 13.25 parts per million or 0.4 parts per thousand in the PTFE dispersion.

In the preferred embodiment of the present invention, no other PFAS materials are intentionally added to the PTFE dispersions to compensate for the lack of GenX, PFOA, PFOS, or for any other reason.

As PTFE powders are used with PFOA levels as low as required by the present invention, the avoidance of PFOS in the PTFE dispersions of the present invention is even more of a technical challenge, overcome by the present invention, as PFOS, like PFOA, is an effective material in the use of PTFE dispersions in plating applications.

As PTFE powders are used with PFOA levels as low as required by the present invention, the avoidance of GenX in the PTFE dispersions of the present invention is even more of a technical challenge as GenX, like PFOA, is an effective material in the use of PTFE dispersions in plating applications.

PFOS may be introduced into PTFE dispersions through the use of certain surfactant materials. Fluorocarbon surfactants have been widely used in the manufacture of PTFE dispersions. The surfactants that have been most commonly used in this field have been surfactants with a chain of eight carbon atoms, known as perfluorooctyl, or PFOS. Such eight chain molecules are generally less soluable than other fluorocarbon surfactants with shorter chains of carbon atoms or other types of surfactants. These eight chain carbon molecules therefore tend to be more stable. This feature relates to the effectiveness experienced in the art with such eight carbon chain molecules. This feature also directly relates to a problem with such eight carbon chain based fluorocarbon surfactants as such surfactants bioaccumulate to a greater degree than fluorocarbon surfactants with shorter chains of carbon atoms or other varieties of surfactants.

In addition to the bioaccumulation of PFOS from such fluorocarbon surfactants, which is viewed as problematic for the environment and by some regulators, PFOS has further been suspected of causing developmental and systemic toxicity in laboratory animals. This therefore being an additional concern making the avoidance of PFOS or its limitation advantageous.

It is therefore an object of the present invention to form PTFE dispersions using surfactants free or essentially free (e.g., sub-trace) PFOS in commercially viable PTFE dispersions.

It is also an object of the present invention to manufacture PTFE dispersions free of fluorocarbon surfactants in general as even fluorocarbon surfactants with carbon chains less than eight may still be more problematic to the environment, humans, and/or animals than non-fluorocarbon surfactants. U.S. Pat. No. 8,598,260 discussed general desirability of avoiding fluorocarbon surfactants in such PTFE dispersions. The present invention further discloses the use of hydrocarbon surfactants as a replacement for fluorocarbon surfactants in the manufacture of PTFE dispersions for plating applications. However, in only some of the embodiments of the present invention does not reduce to practice the full avoidance of fluorocarbon surfactants, and even if it did reduce this to practice, fluorocarbon would likely be in dispersions of PTFE powder containing substantially more PFOA and/or GenX as the PTFE powder of the present invention. This is a significant difference between the prior art and the present invention.

A difficulty in using hydrocarbon surfactants instead of some or all fluorocarbon surfactants in a PTFE dispersion is that hydrocarbon surfactants have a much weaker covalent bond between the carbon and hydrogen atoms compared to the bond between carbon and fluorine atoms in fluorocarbon surfactants. Further, by nature, the greater electronegativity of fluorine compared to hydrogen, the lesser the electronegativity of a hydrocarbon surfactant inherently makes a hydrocarbon surfactant less effective in adsorbing onto PTFE particles to provide the desired stability of PTFE within a dispersion and/or plating bath.

Using non-fluorinated surfactants in the manufacture of PTFE dispersions for plating applications is more difficult when using PTFE powder with no PFOA or as low a level of PFOA as in the present invention; however, the present invention includes dispersion formulations to overcome this difficulty. Non-fluorinated surfactants which can be used in the present invention can be hydrocarbon, organic hydrocarbon, siloxane based and/or other types of surfactants.

It is also an object of the present invention to manufacture dispersions including PTFE particles plus particles of one or more other materials.

It is also an object of the present invention to manufacture dispersions of particles of materials other than or in addition to PTFE. Other or additional lubricating, low friction, and release-enabling particles are considered to be included in the present invention. Particles with other properties including, but not limited to, hardness, wear resistance, friction, heat transfer, insulating, conductivity, phosphorescent, medicinal, aesthetic, and other properties would also be considered potentially included under the present invention. In one embodiment of the present invention, combinations of particles plus associated other chemicals are combined into a single dispersion and subsequently with other materials for metalized plating. In some embodiments, the dispersions are pre-mixed with the remaining metalized plating materials.

Particulate matter suitable for practical composite electroless plating may be from nanometers up to approximately 100 microns in size. The specific preferred size range depends on the application involved.

The particulate matter may be selected from a wide variety of distinct matter, such as but not limited to ceramics, glass, talcum, plastics, diamond (polycrystalline or monocrystalline types, natural or manmade by a variety of processes), graphite, oxides, silicides, carbonate, carbides, sulfides, phosphate, boride, silicates, oxylates, nitrides, fluorides of various metals, as well as metal or alloys of boron, tantalum, stainless steel, molybdenum, vanadium, zirconium, titanium, tungsten, as well as polytetrafluoroethylene (PTFE), silicon carbide, boron nitride (BN), aluminum oxide, graphite fluoride, tungsten carbide, talc, molybdenum disulfide (MoS), boron carbide and graphite. The boron nitride (BN), without limitation, may be hexagonal or cubic in orientation.

For increased friction on the surface of a resultant coating and/or increased wear resistance, hard particulates, such as but not limited to diamond, carbides, oxides, and ceramics, may be included in the plating bath. Application of an overcoat of a conventional plated layer on top of the composite plated layer is also done in the field in order to further embed the particulate matter within the coating.

For increasing lubrication or a reduction in friction in the resultant coating, additional “lubricating particles,” such as boron nitride (BN), talc, molybdenum disulfide (MoS), graphite or graphite fluoride among others may be included in the plating bath. These lubricating particles may embody a low coefficient of friction, dry lubrication, improved release properties, and/or repellency of contaminants such as water and oil.

For light emitting properties in the resultant coating, particulates with phosphorescent properties such as, but not limited to, calcium tungstate may be included in the plating bath.

For identification, authentication, and tracking properties in the resultant coating, various particulate and solid materials may be included in the plating bath so they will be incorporated into the coating and detectable either visually, under magnified viewing, or detection with a suitable detector.

The PTFE dispersion may be used for composite plating (electroless, electrolytic, immersion, brush and other varieties), anodizing, topical treatments using PTFE, other surface treatments, or any application where PTFE particulate matter is needed in a dispersed form.

In plating applications, the metal or alloy matrix may be applied through an electroless, electrolytic, or other method. The metal or alloy may be selected from suitable metals capable of being deposited. Such metals include, without limitation, nickel, cobalt, copper, gold, palladium, iron, other transition metals, and mixtures thereof, and any of the metals deposited by the autocatalytic process in Pearlstein, F., “Modern Electroplating”, Ch. 31, 3^{rd} Ed., John Wiley & Sons, Inc. (1974). Preferably, the metals selected are from the group including nickel, cobalt and copper.

Such metals may be introduced to the plating bath within a compound that aids and allows the dissolution of the metal portion in the bath solution. Such compounds may include, without limitation, sulfates, chlorides, acetates, phosphates, carbonates, sulfamates, and hypophosphites.

In electroless plating processes, reducing agents are used as electron donors. When reacted with the free floating metal ions in the bath solution, the electroless reducing agents reduce the metal ions, which are electron acceptors, to metal for deposition onto the article. The use of a reducing agent avoids the need to employ a current, as required in conventional electroplating. Common reducing agents are sodium hypophosphite, nickel hypophosphite, sodium borohydride, n-dimethylamine borane (DMAB), n-diethylamine borane (DEAB), formaldehyde, and hydrazine.

The PTFE particulate matter may be in any suitable form. Generally the PTFE may be from nanometers in size up to approximately 100 microns in size. The specific preferred size range depends on the application involved. PTFE with a primary particle size of about 0.2 microns is a preferred size for electroless nickel PTFE plating. PTFE particles may have a variety of shapes from round to oblong and others.

In order to formulate a PTFE dispersion according to the present invention, any known particulate matter stabilizers (PMSs) may be used in the PTFE dispersion so long as the dispersion is free or essentially free of GenX and/or PFOS and/or has a concentration of PFOA less than the levels disclosed herein.

Such PMSs include, without limitation, sodium salts of polymerized alkyl naphthalene sulfonic acids, disodium mono ester succinate (anionic, cationic, and nonionic groups which may be used alone, or in combination), fluorinated alkyl polyoxyethylene ethanols, tallow trimethyl ammonium chloride, siloxane, dispersants, wetting agents, tensides, surfactants, and any of the PMSs, or any other materials, disclosed in U.S. Pat. No. 6,306,466, except those which are not free or essentially free of PFOS and/or PFOA, which is incorporated herein by reference. However, the choice of PMS can result in a non-commercially viable PTFE dispersion, whereas other choices may result in a commercially viable PTFE dispersion in particular concentrations or when additional compounds are introduced to the bath. For example, the use of one or more PMSs, alone or in combination, can cause coagulation, separation, solidification, and other deficiencies in the composition of a PTFE dispersion. Moreover, the use of one or more PMSs may cause deficiencies in the electroless metalizing bath, even if the appearance of the PTFE dispersion appears acceptable. For example, the use of one or more PMSs, alone or in combination, may cause the PTFE particles to separate from the electroless metalizing bath immediately or with time, heat, chemical reactions, etc., to agglomerate, settle, float, or otherwise not remain properly dispersed in the electroless metalizing bath. Further, the use of one or more PMSs, alone or in combination, may cause performance deficiencies in the electroless metalizing bath such as reduced plating rate, reduced bath life, reduced tolerance to agitation, increased consumption of materials especially the PTFE dispersion in the electroless metalizing bath.

In the case of composite electroless PTFE plating, the electroless metallizing bath, depending upon whether the PTFE dispersion is free or essentially free of GenX, PFOS, and/or PFOA, may also contain one or more complexing agents and the agents may be of different types and different concentrations. More than one complexing agent may be needed. The complexing agent acts as a buffer to help control pH and maintain control over the “free” metal salt ions in the solution, all of which aids in sustaining a proper balance in the bath solution.

The electroless metallizing bath may further contain a pH adjuster to also help control pH levels in the bath. Suitable pH adjusters may buffer the plating bath at a desired pH range.

Some materials may serve one or more functions within an electroless plating bath. For example, ammonium hydroxide may serve as both a pH adjuster as well as a complexer; cadmium, aluminum, copper and others materials are both a stabilizer and a brightener, lactic acid is both a complexer and a brightener, some sulfur compounds like thiourea are both stabilizers and accelerators depending on concentration, and there are other multipurpose ingredients useful in electroless plating baths.

Ingredients typical in electroless plating and useful in the present invention include, but are not limited to the following materials in the following general categories:

Complexers

Acetic Acid, Alanine-beta, Aminoacetic Acid, Ammonium Bicarbonate, Ammonium Carbonate, Ammonium Chloride, Ammonium Hydroxide, Boric Acid, Citric Acid, Citrates, EDTA, Ethylenediamine, Fluoboric Acid, Glycerine, Glycine, Glycolic Acid, Glycolic Acid Salts, Hydroxyacetic Acid, Lactic Acid, Maleic Anhydride, Malic Acid, Malonic Acid, Orthoboric Acid, Oxalic Acid, Oxalic Acid Salts, Propionic Acid, Sodium Acetate, Sodium Glucoheptonate, Sodium Hydroxyacetate, Sodium Isethionate, Sodium or Potassium Pyrophosphate, Sodium Tetraborate, Succinic Acid, Succinate Salts, Sulfamic Acid, Tartaric Acid, Triethanolamine, Monocarboxylic Acids, Dicarboxylic Acids, Hydrocarboxylic Acids, Alkanolamines, and combinations and variations of such materials.

Stabilizers

2 Amino-Thiazole, Antimony, Arsenic, Bismuth Compounds, Cadmium Compounds, Lead Compounds, Heavy Metal Compounds, Iodobenzoic Acid, Manganese Compounds, Mercury Compounds, Molybdenum Compounds, Potassium Iodide, Sodium Isethionate, Sodium Thiocyanate, Sulfur Compounds, Sulfur Containing Aliphatic Carbonic Acids, Acetylenic Compounds, Aromatic Sulfides, Thiophenes, Thionaphthalenes, Thioarols, Thiodipropionic Acid, Thiodisuccinic Acid, Tin Compounds, Thallium Sulfate, Thiodiglycolic Acid, Thiosalicylic Acid, Thiourea, and combinations and variations of such materials.

Brighteners

Aluminum, Antimony Compounds, Cadmium Compounds, Copper, Lactic Acid, and combinations and variations of such materials.

pH Controllers

Ammonium Bicarbonate, Ammonium Carbonate, Ammonium Chloride, Ammonium Hydroxide, Potassium Carbonate, Potassium Hydroxide, Sodium Hydroxide, Sulfamic Acid, Sulfuric Acid, and combinations and variations of such materials.

Buffers

Borax, Boric Acid, Orthoboric Acid, Succinate Salts, and combinations and variations of such materials.

Reducing Agents

DMAB, DEAB, Hydrazine, Sodium Borohydride, Sodium Hypophosphite, and combinations and variations of such materials.

Accelerators

Fluoboric Acid, Lactic Acid, Sodium Fluoride, Anions of some mono and di carboxylic acids, fluorides, borates, and combinations and variations of such materials.

Metal Salts

Cobalt Sulfate, Copper Sulfate, Nickel Sulfate, Nickel Chloride, Nickel Sulfamate, Nickel Acetate, Nickel Citrate, and combinations and variations of such materials.

Historically, electroless nickel and composite electroless plating processes have included heavy and/or toxic metals in the plating bath to overcome the inherent instability of the plating bath. Lead has been the most commonly used material to serve this purpose. Cadmium has also been used widely over the years as a brightener for electroless nickel coatings. But this incorporation of heavy metals into the plating baths presents multiple challenges. The heavy metals must be added in a sufficient amount to prevent the decomposition of the plating bath, but an increased concentration beyond the necessary level required to prevent the decomposition results in cessation or reduction of the plating rate. Increasingly stringent rules and regulations that restrict or prohibit the use of heavy metals, such as the Removal of Hazardous Substances (RoHS) and End-Of-Life Vehicle (ELV) Regulations. However, U.S. Pat. Nos. 7,744,685 and 8,147,601 disclose stable composite electroless nickel plating baths without the use of heavy and/or toxic metals. These patents are included herein by reference.

The electroless nickel and composite electroless nickel solutions of the present invention may contain heavy metals or may be essentially free of heavy metals, which means that no such heavy metal is added to the plating bath and/or the heavy metal concentration should be no more than a level that would cause the coating on articles plated in said bath to have a heavy metal concentration in excess of any relevant regulations. The solutions of the present invention may also contain heavy metals less toxic and/or subject to fewer regulations than lead, cadmium and others.

The article to be coated may require preliminary preparation prior to contact. This preparation includes the removal of surface contaminants. For example, this process may involve degreasing, alkaline cleaning, electrocleaning, water or solvent rinsing, acid activation, pickling, ultrasonic cleaning, physical modification of the surface, vapor or spray treatments, etc.

The mechanism by which a coating is formed on an article in composite electroless plating is well known in the art. For example, U.S. Pat. No. 4,830,889, which is incorporated herein by reference, describes the electroless reaction mechanism. Generally, metal ions are reduced to metal by action of chemical reducing agents, which are electron donors. The metal ions are electron acceptors that react with the electron donors. The article to be coated itself may act as a catalyst for the reaction. The reduction reaction results in the deposition of a coating with the metal (or electroless metal) onto the surface of the article.

The article to be coated may be any substrate or material capable of being coated through composite electroless plating. Some examples of such articles are components in high wear, abrasive, impact, cutting, grinding, molding, frictional, and sliding applications, typically metal or with metal, but other materials may also be used (such as but not limited to plastics).

Once completed, this electroless plating process results in an article with a coating containing metal or metal alloy and PTFE particulate matter. In this regard, increasingly stringent rules and regulations that restrict or prohibit the use of certain materials, such as the End-Of-Life Vehicle (ELV) Regulations and Restriction of Certain Hazardous Substances (RoHS), means that the present invention has an extra added benefit of reducing or eliminating the potential for certain materials to be incorporated into the metal or metal alloy coating. These regulations are designed to reduce the presence of certain materials with health and/or environmentally problematic qualities in articles. Because particulate matter stabilizers and other materials can stabilize the plating bath as well and overcome the increase in instability inherent from adding insoluble or sparingly soluble particulate matter, use of the present invention complies with such regulations because it does away with the need for potentially costly and certainly environmentally regulated materials in composite electroless plating, which thereby avoids the incorporation of such hazardous materials in the articles plated in such baths.

Generally, the electroless metal in the deposited coating is a metal or a metal alloy, usually in the form of a metal, a metal and phosphorous, or a metal and boron. The metal or metal alloy is derived from the metal salt used in the bath. Examples of the metal or metal alloy are nickel, nickel-phosphorous alloy, nickel-boron alloy, cobalt, cobalt-phosphorous alloy, and copper. PTFE and/or other particulate matter can be added to the above.

Specifically, “electroless” nickel is an alloy of 88-99% nickel and the balance with phosphorous, boron, and/or a few other possible elements. Electroless nickel is commonly produced in one of four alloy ranges: low (1-4% P), medium (6-8% P), or high (10-12% P) phosphorous, and electroless nickel-boron with 0.5-3% B. Each variety of electroless nickel thus provides properties with varying degrees of hardness, corrosion resistance, magnetism, solder-ability, brightness, internal stress, and lubricity. All varieties of electroless nickel can be applied to numerous articles, including metals, alloys, and nonconductors.

Electroless nickel is produced by the chemical reaction of a nickel salt and a reducing agent. Typical electroless nickel baths also include one or more complexing agents, buffers, brighteners when desirable, and various stabilizers to regulate the speed of metal deposition and avoid decomposition of the solution that is inherently unstable. Diligent control of the solution's stabilizer content, pH, temperature, tank maintenance, loading, and freedom from contamination are essential to its reliable operation. Electroless nickel baths are highly surface area dependent. Surface areas in contact with the bath include the tank itself, in-tank equipment, immersed substrates, and contaminants. Continuous filtration, often submicron, of the solution at a rate of at least ten turnovers per hour is generally recommended to avoid particulate contamination which could lead to solution decomposition or imperfections in the plated layer.

The following examples demonstrate an electroless plating process of the present invention, in which PTFE particulate matter and a metal alloy matrix is plated onto an article.

The plating rate (i.e., the rate at which a plated coating deposits from the plating bath onto the article being plated) is measured by the thickness of coating achieved per unit of time. Microns or mils per hour are common measures of plating rate.

### Example 1

Five separate dispersions were produced by dispersing a dry PTFE particulate matter that is essentially free of PFOA (i.e., understood in the art to be at most only trace amounts of PFOA in the PTFE) and made without GenX into aqueous solutions containing a mixture of PMSs that do not contain PFOS (i.e., understood in the art to be at most only trace amounts of PFOS).

Each of the five dispersions were analyzed by High Performance Liquid Chromatography Thermospray Mass Spectrometry (HPLC/TS/MS). The analysis demonstrated PFOA concentrations in each of the five dispersions as 1) nondetectable at less than 100 parts per trillion, 2) 0.613 parts per billion, 3) 8.12 parts per billion, 4) less than 15 parts per billion, and 5) less than 5 parts per billion, respectively.

A quantity of each of the five PTFE dispersions was introduced into five separate medium phosphorous type electroless nickel composite plating baths in amount ranging from 2 to 10 grams of dispersion per liter of each plating bath. Each bath included a nickel salt providing a nickel metal concentration of between 3.3 to 6 grams per liter in the plating bath, a reducing agent of sodium hypophosphite at a concentration of between 25 and 30 grams per liter, and other components typical of electroless nickel baths, but free or essentially free of any PFOA or PFOS. The plating bath was operated at the parameters of pH 4.8 to 6.0, temperatures of 80 to 90 degrees Celsius, and mild stirring agitation.

Steel panels measuring 2 cm by 5 cm were prepared by an immersion in a hot (180 degrees F.) alkaline cleaning solution for 10 minutes, rinsed in water, immersed in a 30 percent by volume concentration of hydrochloric acid in water at 70 degrees F. for 1 minute, rinsed in water, and then immersed in each of the plating baths prepared as noted herein at the parameters disclosed above. After 60 minutes of plating in the plating bath the panels were removed from each of the plating baths. The surface of the coatings appeared as uniform coated surfaces with a silver-gray or bluish-silver-gray color. The coating on the panel was analyzed as follows.

A photomicrograph of cross sections of these coatings at 1000× magnification demonstrated a coating thickness of about 9-11 microns. Chemically dissolving the coating and weighing the PTFE incorporated in the coatings compared to the weight and volume of the entire coatings demonstrated about 10 to 30% of PTFE by volume in the coatings.

The above baths representing the present invention were maintained at the conditions and parameters above for the subsequent plating of additional steel panels until each of the plating baths reached a total usage of 1-10 metal turnovers via replenishment of the plating bath during which the plating rates for each bath remained essentially consistent (in some instances with an adjustment to the pH and/or temperature of each bath). The plating baths were made up and replenished with either one single component solution plus a PTFE dispersion, or a system of three components used for bath make up and replenishment plus a PTFE dispersion.

The PTFE in the plating bath remained well dispersed and did not exhibit any agglomeration, floating, or other signs of de-wetting; and the properties of the coating on these additional panels were consistent with the initial example, thereby demonstrating that the present invention is reproducible and commercially viable to an equal extent as the current state of the art yet free or essentially free of GenX, PFOS and levels of PFOA lower than the prior art as disclosed herein.

### Example 2

Four separate dispersions were produced by dispersing a dry PTFE particulate matter that is essentially free of PFOA (i.e., understood in the art to be at most only trace amounts of PFOA in the PTFE) and made without GenX into aqueous solutions containing a mixture of PMS s that do not contain PFOS (i.e., understood in the art to be at most only trace amounts of PFOS).

Each of the four dispersions were analyzed by High Performance Liquid Chromatography Thermospray Mass Spectrometry (HPLC/TS/MS). The analysis demonstrated PFOA concentrations in each of the four dispersions as 1) nondetectable at less than 100 parts per trillion, 2) 0.613 parts per billion, 3) 8.12 parts per billion, and 4) less than 15 parts per billion, respectively.

A quantity of each of the four PTFE dispersions was introduced into four separate high phosphorous type electroless nickel composite plating bath in amount ranging from 2 to 10 grams of dispersion per liter of each plating bath. Each bath included a nickel salt providing a nickel metal concentration of between 3.3 to 6 grams per liter in the plating bath, a reducing agent of sodium hypophosphite at a concentration of between 25 and 30 grams per liter, and other components typical of electroless nickel baths, but free or essentially free of any PFOA or PFOS. The plating bath was operated at the parameters of pH 4.8-5.5, temperatures of 80 to 92 degrees Celsius, and mild stirring agitation.

Steel panels measuring 2 cm by 5 cm were prepared by immersion in a hot (180 degrees F.) alkaline cleaning solution for 10 minutes, rinsed in water, immersed in a 30 percent by volume concentration of hydrochloric acid in water at 70 degrees Fahrenheit for 1 minute, rinsed in water, and then immersed in each the plating baths prepared as noted herein at the parameters disclosed above. After 60 minutes of plating in this plating bath the panels were removed from each of the plating baths. The surface of the coatings appeared as uniform coated surfaces with a silver-gray or bluish-silver-gray color. The coating on the panel was analyzed as follows.

A photomicrograph of cross sections of these coatings at 1000× magnification demonstrated a coating thickness of about 7 to 9 microns. Chemically dissolving the coating and weighing the PTFE incorporated in each of the coatings compared to the weight and volume of the entire coatings demonstrated about 10 to 30% of PTFE by volume in the coatings.

The above baths representing the present invention were maintained at the conditions and parameters above for the subsequent plating of additional steel panels until each of the plating baths reached a total usage of 1-7 metal turnovers via replenishment of the plating bath during which the plating rates for each bath remained essentially consistent (in some instances with an adjustment to the pH and/or temperature of each bath). The plating baths were made up and replenished with either one single component solution plus a PTFE dispersion, or a system of three components used for bath make up and replenishment plus a PTFE dispersion.

The PTFE in the plating bath remained well dispersed and did not exhibit any agglomeration, floating, or other signs of de-wetting; and the properties of the coating on these additional panels were consistent with the initial example, thereby demonstrating that the present invention is reproducible and commercially viable to an equal extent as the current state of the art yet free or essentially free of GenX, PFOS and levels of PFOA lower than the prior art as disclosed herein.

### Example 3

Three separate dispersions were produced by dispersing dry PTFE particulate matter into three separate aqueous solutions.

The first dispersion contained a dry PTFE particulate matter made without GenX and with a PFOA content between 300 and 400 parts per million dispersed with a mixture of PMSs that do not contain PFOS (i.e., understood in the art to be at most only trace amounts of PFOS).

The second dispersion contained a dry PTFE particulate matter made without GenX and that is essentially free of PFOA (i.e., understood in the art to be at most only trace amounts of PFOA in the PTFE) with the same mixture of PMSs that do not contain PFOS (i.e., understood in the art to be at most only trace amounts of PFOS). This dispersion analyzed by High Performance Liquid Chromatography Thermospray Mass Spectrometry (HPLC/TS/MS). The analysis demonstrated a PFOA concentration nondetectable at less than 100 parts per trillion.

The third dispersion contained the same PTFE particulate matter as the second dispersion noted above that is essentially free of PFOA (i.e., understood in the art to be at most only trace amounts of PFOA in the PTFE) with a mixture of PMSs including a PMS manufactured by the 3M company under the name of FC-170 that contains PFOS. This dispersion analyzed by High Performance Liquid Chromatography Thermospray Mass Spectrometry (HPLC/TS/MS). The analysis demonstrated a PFOA concentration nondetectable at less than 100 parts per trillion.

A quantity of each of the three PTFE dispersions was introduced into three separate but identical electroless nickel composite plating bath in amount of 6 grams of dispersion per liter of each plating bath. Each bath included a nickel salt providing a nickel metal concentration of 5 grams per liter in the plating bath, a reducing agent of sodium hypophosphite at a concentration of 25 grams per liter, and other components typical of electroless nickel baths, but free or essentially free of any PFOA or PFOS other than any such PFOA or PFOS noted in each of the dispersions above. The plating baths were operated at the parameters of pH 5.5, temperature of 85 degrees Celsius, and mild stirring agitation.

Steel panels measuring 2 cm by 5 cm were prepared by an immersion in a hot (180 degrees Fahrenheit) alkaline cleaning solution for 10 minutes, rinsed in water, immersed in a 30 percent by volume concentration of hydrochloric acid in water at 70 degrees Fahrenheit for 1 minute, rinsed in water, and then immersed in each the plating baths prepared as noted herein at the parameters disclosed above. After 60 minutes of plating in this plating bath the panels were removed from each of the plating baths.

The plating bath that included the first dispersion as noted above did not exhibit any agglomeration, floating, or other signs of de-wetting. The surface of the coating on the panel from this plating bath appeared as a uniform coated surfaces with a silver-gray color. A photomicrograph of cross sections of this coating at 1000× magnification demonstrated a coating thickness of about 7 microns. Chemically dissolving the coating and weighing the PTFE incorporated in each of the coatings compared to the weight and volume of the entire coatings demonstrated about 25% of PTFE by volume in the coatings.

The plating bath that included the second dispersion as noted above exhibited agglomeration and floating of the PTFE in the plating bath. The surface of the coating on the panel from this plating bath appeared uneven and modeled in appearance with streaks visible in the coating. A photomicrograph of cross sections of this coating at 1000× magnification demonstrated a coating thickness of about 6 microns. Chemically dissolving the coating and weighing the PTFE incorporated in each of the coatings compared to the weight and volume of the entire coatings demonstrated about 18% of PTFE by volume in the coatings.

The plating bath that included the third dispersion as noted above did not exhibit any agglomeration, floating, or other signs of de-wetting. The surface of the coating on the panel from this plating bath appeared as a uniform coated surfaces with a bluish-silver-gray color. A photomicrograph of cross sections of this coating at 1000× magnification demonstrated a coating thickness of about 7 microns. Chemically dissolving the coating and weighing the PTFE incorporated in each of the coatings compared to the weight and volume of the entire coatings demonstrated about 25% of PTFE by volume in the coatings.

The three trials in this experiment demonstrate the utility of PFOA and PFOS in plating with PTFE. These three trials further demonstrate the significance of the PMS(s) in obtaining commercially viable plating bath and coating results when using PTFE that is free or essentially free of PFOA.

### Example 4

Four separate dispersions were produced by dispersing dry PTFE particulate matter into aqueous solutions. Each of the dispersion contained 60% by weight of a dry PTFE particulate matter made without GenX and that was essentially free of PFOA (i.e., understood in the art to be at most only trace amounts of PFOA in the PTFE) and one or more PMSs that did not contain PFOS (i.e., understood in the art to be at most only trace amounts of PFOS) nor did the PMS contain any fluorinated material. Each dispersion was analyzed by High Performance Liquid Chromatography Thermospray Mass Spectrometry (HPLC/TS/MS). The analysis demonstrated a PFOA concentration of 0.613 parts per billion in each of the dispersions.
Dispersion 4-1 contained a non-ionic hydrocarbon surfactant made without fluorsurfactant or fluorine-based materials.
Dispersion 4-2 contained an organic surfactant made without fluorsurfactant or fluorine-based materials.
Dispersion 4-3 contained a cationic siloxane based surfactant made without fluorsurfactant or fluorine-based materials.
Dispersion 4-4 contained a non-ionic hydrocarbon surfactant made without fluorsurfactant or fluorine-based materials and a cationic siloxane based surfactant made without fluorsurfactant or fluorine-based materials.

Each of the PTFE dispersions was introduced into an electroless nickel composite plating bath in an amount of 6 grams of dispersion per liter of plating bath. Each plating bath included a nickel salt providing a nickel metal concentration of 5 grams per liter in the plating baths containing dispersions, a reducing agent of sodium hypophosphite at a concentration of 25 grams per liter, and other components typical of electroless nickel baths, but free or essentially free of any PFOA or PFOS. The plating bath was operated at the parameters of pH 5.9, temperature of 85 degrees Celsius, and mild stirring agitation.

Steel panels measuring 2 cm by 5 cm were prepared by an immersion in a hot (180 degrees Fahrenheit) alkaline cleaning solution for 10 minutes, rinsed in water, immersed in a 30 percent by volume concentration of hydrochloric acid in water at 70 degrees Fahrenheit for 1 minute, rinsed in water, and then immersed in each of the plating baths prepared as noted herein at the parameters disclosed above. After 60 minutes of plating in this plating bath the panel was removed from the plating baths.

This process of plating substrates, analyzing the substrates, analyzing the baths, and replenishing the baths was continued until each bath reached 1 metal turnover, and until the bath containing dispersion 4-4 reached 7 metal turnovers. Throughout the process, the pH, temperature, concentration, and agitation were maintained. Throughout the process, the plating rates were measured. As the plating rate decreased with increased metal turnovers, as is typical of electroless nickel plating baths in commercial use, the temperature and pH of the plating bath were increased to maintain a commercially viable plating rate, which also is typical. These plating processes were performed on each of the plating baths over the course of a number of days. This process is representative of the typical usage of a plating bath in a commercial practice.

None of the plating baths exhibited any agglomeration, floating, or other signs of de-wetting of the PTFE. The surface of the coating on the panels from each of the plating baths appeared as uniform coated surfaces with a silver-gray or silver-gray-blue color. A photomicrograph of cross sections of these coatings at 1000× magnification demonstrated a coating thickness of about 12 microns. Chemically dissolving the coatings from each of the panels and weighing the PTFE incorporated in the coating compared to the weight and volume of the entire coatings demonstrated about 20-25% of PTFE by volume in the coating.

This experiment demonstrates PTFE dispersions being used with commercially viable performance, where the PTFE dispersion is made without fluorinated surfactants, GenX, and PFOS, and where the PFOA is at a verified concentration substantially below all prior art.

### Example 5

A dispersion was produced by dispersing dry PTFE particulate matter into and aqueous solution. The dispersion contained 60% by weight of a dry PTFE particulate matter made without GenX and that was essentially free of PFOA (i.e., understood in the art to be at most only trace amounts of PFOA in the PTFE) and a non-ionic hydrocarbon surfactant made without fluorsurfactant or fluorine-based materials and a cationic siloxane based surfactant made without fluorsurfactant or fluorine-based materials. Neither PMS contained PFOS (i.e., understood in the art to be at most only trace amounts of PFOS). The dispersion was analyzed by High Performance Liquid Chromatography Thermospray Mass Spectrometry (HPLC/TS/MS). The analysis demonstrated a PFOA concentration of 0.613 parts per billion in the dispersion.

The PTFE dispersions were introduced into an electroless nickel composite plating bath in amount of 6 grams of dispersion per liter of plating bath. The plating bath included a nickel salt providing a nickel metal concentration of 3.3 grams per liter in the plating baths containing dispersions, a reducing agent of sodium hypophosphite at a concentration of 16.5 grams per liter, and other components typical of electroless nickel baths, but free or essentially free of any PFOA or PFOS. The plating bath was operated at the parameters of pH 5.9, temperature of 85 degrees Celsius, and mild stirring agitation.

A steel panel measuring 2 cm by 5 cm were prepared by an immersion in a hot (180 degrees Fahrenheit) alkaline cleaning solution for 10 minutes, rinsed in water, immersed in a 30 percent by volume concentration of hydrochloric acid in water at 70 degrees Fahrenheit for 1 minute, rinsed in water, and then immersed in the plating bath prepared as noted herein at the parameters disclosed above. After 60 minutes of plating in this plating bath the panel was removed from the plating baths.

This process of plating substrates, analyzing the substrates, analyzing the baths, and replenishing the baths was continued until the bath reached 11 metal turnovers. Throughout the process, the pH, temperature, concentration, and agitation were maintained. Throughout the process, the plating rates was measured. As the plating rate decreased with increased metal turnovers, as is typical of electroless nickel plating baths in commercial use, the temperature and pH of the plating bath were increased to maintain a commercially viable plating rate. These plating processes were performed in the plating baths over the course of a number of days. This process is representative of the typical usage of a plating bath in a commercial practice. The plating bath was made up and replenished with a single component solution plus a PTFE dispersion.

The plating bath did not exhibit any agglomeration, floating, or other signs of de-wetting of the PTFE. The surface of the coating on the panels from each of the plating baths appeared as uniform coated surfaces with a silver-gray or silver-gray-blue color. A photomicrograph of cross sections of the coating on the panels at 1000× magnification demonstrated a coating thickness of about 7 to 12 microns. Chemically dissolving the coatings from each of the panels and weighing the PTFE incorporated in the coating compared to the weight and volume of the entire coatings demonstrated about 20-25% of PTFE by volume in the coating.

This experiment demonstrates PTFE dispersions being used with commercially viable performance, where the PTFE dispersion is made without fluorinated surfactants, GenX, and PFOS, and where the PFOA is at a verified concentration substantially below all prior art.

1. An aqueous bath for electrolessly plating an article comprising the elements of:
a metal salt,
a reducing agent,
a complexing agent and
a dispersion of PTFE particulate matter comprising at least one particulate matter stabilizer;
wherein said dispersion comprises 400 parts or less of perfluorooctanoic acid (PFOA) per million, and said bath is used to form a coating including PTFE on an article.

2-3. (canceled)

4. The aqueous bath of claim 1, wherein the average particle size of said PTFE particulate matter is 0.05 to 100 microns.

5. (canceled)

6. The aqueous bath of claim 1, wherein any fluorocarbon materials in said dispersion have no chains of fluorocarbons of eight or longer.

7. The aqueous bath of claim 1, wherein said elements are further essentially free of perfluorosurfactant sulfonate (PFOS).

8. (canceled)

9. The aqueous bath of claim 1, wherein the coating formed on an article from said aqueous bath is conformant with ELV and RoHS regulations.

10-12. (canceled)

13. The aqueous bath of claim 1, wherein said bath further comprises particulate matter selected from a group consisting of diamond, silicon carbide, boron nitride (BN), aluminum oxide, graphite fluoride, tungsten carbide, talc, molybdenum disulfide (MOS2), boron carbide, graphite, lubricating particles, wear resistant particles, and phosphorescent particles.

14. The aqueous bath of claim 1, wherein said dispersion comprises more than one type of particulate matter stabilizer.

15. The aqueous bath of claim 1, wherein the concentration of PFOS in said dispersion is less than 0.4 parts per thousand.

16. The aqueous bath of claim 1, wherein said dispersion further comprises at least one of hydrocarbon and fluorocarbon particulate matter stabilizers.

17. The aqueous bath of claim 1, where said dispersion is absent fluorocarbon particulate matter stabilizers.

18. The aqueous bath of claim 1, wherein said dispersion further comprises 25 parts per billion or less of PFOA.

19-24. (canceled)

25. The aqueous bath of claim 1, wherein said dispersion contains a non-ionic hydrocarbon surfactant made without fluorosurfactant or fluorine-based materials.

26. The aqueous bath of claim 1, wherein said dispersion contains an organic surfactant made without fluorosurfactant or fluorine-based materials.

27. The aqueous bath of claim 1, wherein said dispersion contains a cationic siloxane based surfactant made without fluorosurfactant or fluorine-based materials.

28. (canceled)

29. A dispersion comprising PTFE particulate matter and at least one particulate matter stabilizer, wherein said dispersion comprises 400 parts per million or less of PFOA, and said dispersion is usable for an electroless plating bath to form a coating including PTFE particulate matter on an article.

30. The dispersion of claim 29, wherein said dispersion is compliant with Registration, Evaluation, Authorisation, and Restriction of Chemicals (REACH) as published by the European Commission of the European Union.

31. The dispersion of claim 29, wherein said dispersion contains a non-ionic hydrocarbon surfactant made without fluorosurfactant or fluorine-based materials.

32. The dispersion of claim 29, wherein said dispersion contains an organic surfactant made without fluorosurfactant or fluorine-based materials.

33. The dispersion of claim 29, wherein said dispersion contains a cationic siloxane based surfactant made without fluorosurfactant or fluorine-based materials.

34. The dispersion of claim 29, wherein said dispersion contains a non-ionic hydrocarbon surfactant made without fluorosurfactant or fluorine-based materials and a cationic siloxane based surfactant made without fluorosurfactant or fluorine-based materials.

35-63. (canceled)
